(19) United States
(12) Patent Application Publication
(10) Pub. No.: US 2001/0040800 A1
(43) Pub. Date: Nov. 15, 2001

(54) Luminary device decorated with color changing film

(76) Inventors: M. Scott Carpenter, Racine, WI (US); Jose Porchia, Greenfield, WI (US); Frederick H. Martin, Racine, WI (US)

Correspondence Address: S.C. JOHNSON & SON, INC., 1525 HOWE STREET, RACINE, WI, 53403-2236, US

(21) Appl. No.: 09/729,288

(22) Filed: Dec. 4, 2000

Related U.S. Application Data
(63) Continuation-in-part of application No. 09/550,285, filed on Apr. 14, 2000.

(51) Int. Cl. F21V 9/00; F21L 19/00

(52) U.S. Cl. 362/166; 362/293; 362/311; 362/307; 362/181; 362/161

(57) ABSTRACT

A decorated luminary product includes either a candle (or other light source) or a holder for containing the candle (or other light source), having a mirror film adhered thereto to provide a pleasing visual effect. A decorative web of a polymeric mirror film web is preferably heat shrunk to conform to the shape of the candle or the holder. The mirror film is located to cooperate with light emitted by a candle or other light source to augment the visual effect created when the candle is lit, by providing birefringent effects, changes in coloration in accordance with changes in viewing angle, and variations in both reflectivity of ambient light and transmission of light from the candle or other light source.

### RELATED APPLICATION(S)

This is a Continuation-In-Part application of Ser. No. 09/550,285, filed Apr. 14, 2000.

### FEDERALLY SPONSORED RESEARCH OR DEVELOPMENT

Not applicable.

### BACKGROUND OF THE INVENTION

1. Technical Field

The present invention, in general, relates to decorated luminary products, and more particularly relates to candle products decorated by the application of a decorative film having specific color changing or altering properties, either to the candles or to candle holders in which the candles are situated.

2. Background Information

Luminary products, such as candles and candle products come in many shapes, sizes, and designs. While the terms “luminary, luminaries, and luminary products” shall be used herein in reference to combustible active material or fragrance delivery candles, or illumination devices which are wick based and burn a hydrocarbon-based fuel, such as candles, or oil lamps or lanterns, it is to be understood that the invention is not to be so limited. For example, the invention is also applicable to illuminating devices in which the source of illumination is an electric light bulb, or other similar devices. Some luminary products, such as candles, are intended to stand alone. Others are intended to be held upright as candlesticks, or to be placed in lanterns, jars, and the like. Some candles are intended to be situated in candle holders, and in the case of so-called gel candles and some wax candles, commonly called jar candles, the candles may substantially fill the volume of the holders in which the candles are situated. In addition, votive candles are frequently placed in holders, jars, and containers of suitable size. Moreover, it is to be understood that when a luminary, or a candle or candle holder is referred to, it is intended to include other forms of luminary devices as well, such as oil lanterns and lamps and globes for such, including those such devices which are designed to provide a fragrance or other active material to the atmosphere when burned.

In many of these cases, it is desirable to decorate the luminary products to improve their aesthetics, for both when the luminary is displayed unlit, and for when burning. However, it can be difficult and costly to decorate the exterior surface of a luminary or its holder. Also, many known techniques do not provide flexibility in production to easily change the particular decorative design. This limits the ability to provide cost-effectively a variety of designs, or to tailor the designs to the desires of the consumer, or to a specific season, event, motif, holiday or the like. Moreover, there has previously been no means to provide a product having a decorative effect which changes in accordance with its surroundings, the light shining upon it from an exterior source or from a burning candle within the product, and whether the luminary is itself lit or unlit.

Therefore, there is a need in the art for a cost-effective decorating method which permits greater flexibility in production to allow a change from among varied decorative designs, and provides a decorative luminary product which gives differing effects upon the angle of viewing and light incidence.

It has long been known to encase candles in protective material. For example, U.S. Pat. No. 2,137,707, of Wade, et al., relates to a process for packaging tapered candles in a seamless casing formed of a non-fibrous, cellulosic material. The casing may be transparent, translucent and/or colored. In one embodiment, the non-fibrous, cellulosic material is formed into a tube, which is wetted to soften the material for application to the candle. The diameter of the wet tube is substantially equal to the mean diameter of the tapered candle, and as the wet tube is pushed down onto the candle, or a mandrel having the same dimensions as the candle, it stretches as necessary to fit over the wider end of the candle. Then, the covered candle is dried, and the tube forms a protective casing that conforms closely to the shape of the candle, and will retain the candle wax whether in a solid or melted state.

It has also been known to wrap candles in heat-shrinkable films for shipping and display. In U.S. Pat. No. 3,126,682, Krance teaches a method of wrapping candles. A tube of heat-shrinkable film material is loosely formed about the candle by shaping a web of the material about the candle with overlapping longitudinal edges. By grasping the tube just beyond each end of the candle, the wrapped candle is carried past a heat source, by which the material is heat shrunk around the candle. The material selected has two important characteristics: it will not shrink any further once it contacts the surface of the candle, and it holds a high charge of static electricity which causes it to cling when overlapped. Thus, the material is not heat sealed, but rather is held together statically around the candle after shrinking to a tight fit.

It has also been known to apply heat-shrinkable wraps on various objects for decorative purposes. For example, U.S. Pat. No. 3,829,348, of Spiegel et al., relates to decorating three-dimensional objects such as ornaments, glassware, or electric bulbs. The object is decorated by heat-shrinking a decorated tube or band of heat-shrinkable plastic about the object. The tube or band is decorated by applying precut patterns, silk screening, striping or the like, prior to application of the tube or band to the object to be decorated. The plastic is preferably polyvinyl chloride (PVC) or polyethylene, which is uniaxially oriented, resulting in a 30-50 percent diametric shrinkage versus only a 2-10 percent height shrinkage of the tube, resulting in an intimate contact of the entire interior surface of the band or tube with the exterior surface of the decorated object.

Similarly, U.S. Reissue Pat. No. RE. 20,434, of Barrett, Jr., teaches the preparation of a sanctuary candle, wherein the body of the candle is tightly jacketed in a cylindrical transparent film of amorphous cellulose, fitted to the candle while still un-dried. It is taught that the film may be either clear or colored, and may be combined with a colored glass tube forming the outside of the assembly, which includes a bottom assembly and a cap.

In co-pending patent application Ser. No. 09/550,285, filed Apr. 14, 2000, Kotary et al. disclose a technique for the application of a shrink-wrap decorative film to a candle for the purpose of providing a cost-effective and flexible method for providing a variety of decorative effects upon candle products. However, this method is directed specifically to shrink-wrap films of a specific nature, which are limited in the degree to which they may be decorated, and limited in the visual effects attainable therewith.

In addition to the above, there are a number of references which teach the application of decorative materials, such as labels, to the exterior surfaces of various items. For Example, Branch et al., in U.S. Pat. No. 5,879, 496, teach a method for labeling convex surfaces, such as bottles, eggs, Christmas tree ornaments, and the like, by attachment of both ends of a segment of heat shrinkable material to the surface with an adhesive, followed by heat shrinking the major portion of the segment to a tight adherence to the surface. Conventional heat-shrink materials are employed, having a high degree of orientation of shrinkage. Heat shrinkable polyester films having particularly favorable shrink characteristics are taught by Mori et al., U.S. Pat. No. 5,932,685. The shrink-wrap films of this reference are said to be preferable due to the fact that not only do they undergo relatively little longitudinal sinking when shrunk, but that they also have very few wrinkles, shrinkage spots, or strains remaining after shrinkage.

There are a number of films having optical or color changing characteristics, but none which have been suggested as suitable for shrink-wrap application to a substrate. The films preferred for the present invention exhibit high gloss, and reflectivity. In addition, they are preferably iridescent, exhibiting differing refractance and reflectance at differing viewing angles or at differing angles of lighting. Further, high transparency is desirable, to allow background lighting to show through, such as when applied to the outer surface of a candle holder, so that light from the burning candle will show through the film, while the film simultaneously refracts the light from the candle, and reflects light from outside, to provide a striking visual effect. None of the previously discussed references provide such an effect.

Among references which teach films having optical properties of interest are U.S. Pat. No. 5,882,774, of Jonza et al., incorporated herein by reference, which teaches birefringent multilayer optical films in which light reflecting devices are based upon multiple polymeric layers of crystalline or semi-crystalline polyester in combination with layers of a selected second polymer, for example a polyester or polystyrene, wherein said film is stretched in at least one direction to at least twice that direction's unstretched dimension, thus creating a film having an average reflectivity of at least 50% over at least a 100 nm wide band. Thus, the patent teaches the preparation of multilayer films having high reflectivity, for both s-polarized and p-polarized light for any incident direction in the case of mirrors, and for the selected direction in the case of polarizing devices, over a relatively wide bandwidth. Patentee employs alternating layers of a crystalline naphthalene dicarboxylic acid polyester and a second polymer to provide a reflective polarizer or mirror. Biaxial stretching of the multilayered sheet results in differences between refractive indices of adjoining layers for planes parallel to both axes, thereby resulting in reflection of light in both planes of polarization direction. By proper selection of polymeric film materials, layering, and stretching, a large variety of optical effects may be achieved, including iridescence, reflectivity, transparency, color shift, and light absorption. The content of this patent is incorporated herein by reference in its entirety.

Further, Jonza et al. have taught, in U.S. Pat. No. 6,045,894, a multilayer film including multiple polymeric layers designed and made to enable said film to reflect light in the near infrared portion of the visible spectrum. Accordingly, dependent upon the amount and range of red light reflected, the film may appear to exhibit varying visible color, appearing to be substantially clear when viewed against a white background from a head-on or zero degree observation angle, while appearing to be cyan or reddish when viewed from a different angle. The content of this patent is incorporated herein by reference in its entirety.

In addition to the above, recent PCT applications have been published by Minnesota Mining and Manufacturing Company, in which various polymeric films have been shown having optical characteristics which would provide color shifting and light refractory properties. However, none of these references teaches the use of such materials for the manufacture of labels, much less for candle or luminary purposes. In fact, none of these references indicates that such materials would be suitable for heat shrink application to a substrate, and in fact these publications would teach that such materials would not be suitable for such usage, due to problems in shrinkage.

Further, an overview of multilayer mirror technology appears in SCIENCE, vol. 287, pp. 2451-2456, “Giant Birefringent Optics in Multilayer Polymer Mirrors”, Weber et al., 31 March 2000, incorporated herein by reference in its entirety. The authors teach that conventional polymer film-making processes have been enhanced to fabricate a wide array of giant birefringent optic (GBO) films from commercially available polymers and monomers for use in a range of applications, including high efficiency mirrors, reflective polarizers, decorative products, cosmetics, security films, optoelectronic components, and infrared solar control reflectors.

However, it has not previously been proposed to decorate a luminary product such as a candle or a candle holder with a heat-shrinkable film having properties such that the film changes color as the viewing angle changes, or as the temperature of the substrate changes in accordance with the burning of the luminary. The product thus is visually pleasing and changeable not only during burning, but when displayed unlit. Further, it has not been suggested to decorate a candle or holder, which will be subject to elevated temperatures during normal use, by application of a heat-shrinkable film having such properties. The known art does not suggest such an application, nor does it suggest with any certainty that heat-shrinkable polymers could be used to decorate such a combustible product with the desired result.

### SUMMARY OF THE INVENTION

The present invention addresses the foregoing needs in the art by providing a product and method in which a luminary product is decorated by enveloping the luminary, candle, or holder in a decorative, heat-shrinkable polymer wrap having the specified properties, and heat-shrinking the wrap about the luminary, candle, or candle holder.

The novel luminaries obtained by the practice of this invention produce visual effects which are in some aspects similar to those effects produced by what has been known in the glass industry as Carnival Glass, although by entirely different means. Carnival Glass is a pressed glass which has an iridized surface treatment, made by exposing newly formed hot pressed glass to sprays, fumes, and vapors from heated metallic oxides. These materials form a lustrous coating at the surface of the glass, which looks as if it has rainbows on it, somewhat akin the rainbow colors on the surfaces of soap bubbles. The actual visual effect is created by light interference patterns produced by constantly shifting wavelengths. Such glass was first produced in the early twentieth century by the Fenton Glass Works, and has since been copied by a large number of manufacturers.

As indicated, the effect observed in the present invention is somewhat similar, but differing in major respects. For example, the materials of the present invention produce both mirror and iridescent effects, dependent upon angle of viewing. Further, color shifting results from viewing at differing angles in the present invention, whereas it is not observed in Carnival Glass. Still further, the film materials applied to the luminaries of the present invention exhibit both mirror like reflectivity and transparency, dependent upon not only the angle of incidence of the light, but also the specific spectral properties of the light. Moreover, the films used will often exhibit colors dependent upon the color of the body observed behind the film, or the color of a body reflected by the surface of the film.

In one aspect, the present invention relates to a method of decorating a candle product, and includes the steps of providing a web of a heat-shrinkable polymer having a specific decorative feature and encasing with the web a luminary product. After the encasing step, the web is heated to shrink the web to conform to a shape of the luminary product. In a case in which the luminary product comprises a candle holder, a candle may be inserted into the candle holder to enhance the effect of the polymeric wrap employed. Thus, in one aspect, the present invention relates to a decorated candle product including a candle and a candle holder containing the candle. A decorative web of a heat-shrinkable polymer web having color changing properties is heat shrunk to conform to a shape of the candle or the candle holder. The web has a decorative feature which cooperates with light emitted by the candle to augment the visual effect created when the candle is lit.

These and other aspects, objects, features, and advantages will be more evident from the following description.

### DETAILED DESCRIPTION OF THE PREFERRED EMBODIMENTS

Various embodiments of a decorated luminary product may be formed in accordance with the present invention. In each embodiment, the luminary product is decorated by enveloping an exterior surface in a decorative, heat-shrinkable polymer wrap and heat-shrinking the wrap about the surface to cause it to adhere tightly thereto. While it is possible to cause the decorative wrap of the invention to adhere to the candle product by other means, which means are to be understood to be encompassed by the present invention, this disclosure shall be written in terms of heat shrinking a heat shrinkable film to an adherent condition upon a surface. However, as will be evident to one skilled in the art, the decorative films used in the present decorated luminary device may be applied by such alternative means as attachment with holding devices such as staples, pins, tape, etc., particularly when being attached to candles per se.

As previously indicated, the basic concept of the present invention is the provision of a decorative surface upon a luminary product. The luminary product may comprise a candle, a lamp, or a holder or container for a candle or lamp. For example, the present invention is inclusive of candles having a decorative film on the outer surface thereof, a candle holder having a decorative film on either the inner or outer surface thereof, or a lamp chimney or globe having a decorative film on either the inner or outer surface thereof. As examples of the invention, Applicants believe that decorative candles, in the form of candle sticks, jar candles, or votive candles which either bear a decorative film upon the surface thereof, or are placed within a container, such as a glass jar decorated as taught hereinafter, fall within the scope of the present invention, as well as various configurations of globes or lantern chimneys, usually made of glass, designed to surround, enclose, encompass, retain, or hold candles of various shapes, electric lights, oil burning lamps, or various wicks which burn carbon-based fuel, which globes or lantern chimneys bear upon their surfaces a decorative film in accordance with the teachings of this disclosure. While the use of transparent globes, chimneys, or candle containers (such as jars) is preferred, it is possible to utilize opaque or translucent materials as well, although the visual effect is not as pronounced in such a case.

The present invention is particularly applicable to candles, candle holders, oil lamps, and the like which dispense an active material. Such active materials are well known in the prior art, and may be selected from the group consisting of fragrances, air fresheners, deodorizers, odor eliminators, malodor counteractants, insecticides, insect repellants, medicinal substances, disinfectants, sanitizers, mood enhancers, aroma therapy compositions, and mixtures thereof. The choice of specific active materials present in the luminaries of the present invention, if any, are within the skill of a practitioner of the art to which the present invention applies. However, preferred active materials which may be included in the wax of a candle, or in the oil of an oil burning lamp, include fragrances, insect repellants, insecticides, and deodorizers. Such active materials may be added, in liquid or gel form, to the fuel element of a candle or lamp to be dispersed to the atmosphere upon burning of the fuel.

Thus, the invention broadly encompasses a luminary product having a decorative birefringent, reflective, color altering film associated with it, in a position relative to the flame or light source of the luminary product so as to be effected by the light radiated by the light source as well as by incident ambient light.

The birefringent, reflective, color altering film may be such a film as commonly referred to as a mirror film, available from 3M, of St. Paul, Minn. Such films comprise alternating layers of at least two differing polymers, the film transmitting substantially all incident visible light at approximately a zero degree observation angle, and transmitting substantially all visible light except a selected portion of the spectrum at at least one observation angle greater than a predetermined shift angle. Thus, the film may appear to be clear, i.e. to be transparent, or to exhibit one color when observed at a zero degree observation angle, and to exhibit a different visible color when viewed at an observation angle greater than some predetermined angle. As set forth in U.S. Pat. No. 6,045,894, an exemplary color shift from clear to cyan, a deep greenish blue color, is produced by creating a multilayer film including multiple polymeric layers selected to enable the film to reflect light in the near infrared portion of the visible spectrum at zero degree observation angles, and to reflect red light at angles greater than the “shift” angle, which is that angle, measured relative to an optical axis extending perpendicular to the film, at which the film first appears colored. Dependent upon the amount and range of red light reflected, the film may exhibit a visible color, commonly cyan. Thus, one viewing from the zero observation angle will see through the film while one viewing at the shift angle, or at an angle greater than the shift angle, will see a cyan-colored film. Such films, when provided with an adhesive layer and applied to an item of value, are useful as a means of authentication, which may also be placed directly over other identifying indicia, such as serial numbers of electronic devices, etc.

Such multilayer polymeric films may include hundreds of thin layers, and may contain as many different materials as there are layers in the film. For ease and economy of manufacture, preferred multilayer films have only a few differing materials, and most preferably only two different materials, although the number of layers may be substantially higher. Obviously, the thickness of each layer is relatively small, typically on the order of 0.05 micrometers to 0.45 micrometers thick. As an example, a multilayered polymeric film having alternating layers of crystalline napthalene dicarboxylic polyester and another selected polymer, such as copolyester or copolycarbonate, wherein the layers have a thickness of less than 0.5 micrometers, and wherein the refractive indices of one of the polymers can be as high as 1.9 in one direction and 1.64 in the other direction, provides a birefringent effect useful in the polarization of light. Adjacent pairs of layers, one having a high index of refraction, the other a low index, preferably have a total optical thickness which is on half the wavelength of the light desired to be reflected. For maximum reflectivity the individual layers of a multilayer polymeric film thus have an optical thickness of about one fourth the wavelength of the light to be reflected.

By creating a multilayer film with layers having different optical thicknesses, the film will reflect light of differing wavelengths. By selection of the desired optical thickness and materials, a film may be designed and made to reflect a given bandwidth, or color, of light. As set forth in the abovementioned U.S. Pat. No. 6,045,894, the films found suitable for the present invention comprise a large number of layers, and may comprise a number of materials. There are a number of factors to be considered in choosing the materials of the optical film used in the present invention. First, although the film may be made with three or more different polymers, alternating layers of a first polymer and a second polymer are preferred for manufacturing reasons. Second, one of the two polymers, e.g. the first polymer, must have a stress optical coefficient having a large absolute value, indicating that it must be capable of developing a large birefringence when stretched. Further, this polymer must be capable of maintaining this birefringence after stretching, so that the desired optical properties are retained in the finished film. The second polymer should be chosen so that in the finished film, its refractive index differs significantly, in at least one direction, from the index of refraction of the first polymer. It is also advantageous for neither polymer to have any absorbance bands within the bandwidth of interest, so that all incident light with that bandwidth is either reflected or transmitted.

The present invention is directed to a specific utility of such a film as is taught by the abovementioned U.S. Pat. No. 6,045,894, and films suitable for use in the present invention may be prepared in accordance with the combinations of materials and methods taught by said U.S. patent, incorporated herein by reference. The present invention is directed not to the preparation of a specific film, but to the use of a specific class of film materials in a novel and pleasing manner to achieve a product unanticipated by those familiar with such film materials.

In accordance with the present invention, a luminary having highly decorative visual effects is prepared by bonding to the surface of a candle, or to a surface surrounding and illuminated by a candle or other source of light, a mirror or birefringent film product in accordance with the abovementioned U.S. Patent. This film, having a multitude of alternating layers of polymeric materials having specific indices of refraction, birefringence, and light transmission, may appear to be transparent at one viewing angle, to reflect one color at certain viewing angles, and another color at differing viewing angles, thus providing a “rainbow” or prismatic effect to the viewer when observed. Moreover, this visual effect may be observed not only as a result of the light shed by the candle or the light source encompassed by the film, but as a result of ambient light being reflected and absorbed differently at differing angles of observation. Moreover, the visual effect of the luminary of the present invention will be varied by the color of the fuel element or candle within the candle holder. That is, a white candle will present a very different appearance to the eye than a red or green candle encompassed within the same film wrapped container.

The preferred films suitable for the present invention are commercially available as 3M Colored Mirror Film, and 3M Visible Mirror Film, available from 3M Corporation of St. Paul, Minn. Such films are metal free, multi-layer polymeric films which are thermally stable up to about 125° C., may be formed to a simple curve, may be printed upon, and exhibit shrinkage below about 2 percent after about 15 minutes at 150° C. Such films are available to provide a spectral response in the range of from about 500 to 700 nm (blue/magenta) and in the range of from about 590 to 740 nm (cyan). The Visible Mirror Film version has a reflectivity of close to 98 percent over a spectral range of from about 400 nm to about 1020 nm.

Preferred mirror films for the present invention comprise alternating layers of at least a first polymer and a second polymer; the film appearing substantially clear at approximately a zero degree observation angle, and colored at at least one observation angle greater than a predetermined shift angle. In a preferred embodiment, said film comprises a series of layer pairs having optical thicknesses of between approximately 360 nanometers and approximately 450 nanometers. In such films, said film comprises alternating layers of at least a first polymer and a second polymer; and said film transmits substantially all incident visible light and reflects light having a wavelength of from approximately 720 to 900 nanometers at approximately a zero degree observation angle, and transmits substantially all visible light except a selected portion of red light at at least one observation angle.

In a preferred embodiment of a mirror film useful for the present invention, said film is a multilayer film comprising alternating layers of at least a first polymer selected from the group consisting of polyethylene terephthalate and copolymers incorporating terephthalic acid and polyethylene naphthalate and copolymers incorporating naphthalene dicarboxylic acid, and a second polymer selected from the group consisting of a copolyester of cyclohexane dimethanol, polytetra-methylene ether, methacrylate, a copolymer incorporating polymethyl methacrylate, and polyethylene terephthalate glycol. A still more preferred embodiment of such a film comprises alternating layers of polyethylene naphthalate and polymethyl methacrylate. Alternatively, the film may comprise alternating layers of polyethylene naphthalate and polyethylene terephthalate glycol.

Due to the low shrinkage of such films, they have not previously been suggested for heat shrink application to substrates. Surprisingly, applicants have learned that by careful application and use of controlled techniques, these materials may be applied by heat shrinking to substrates such as candles, candle jars, votive jars, globes, and chimneys, to provide a highly decorative luminary product.

Preferred methods for the application of such films to a substrate in accordance with the present invention are set forth in copending U.S. patent application Ser. No. 09/550,285, filed Apr. 14, 2000, incorporated herein by reference. The teachings of that application are specific to application of a shrink-wrap decorative film to a candle, to provide decorative effects. Similar methods have been found effective in application of the mirror or birefringent film product utilized in the present invention. While the discussion which follows focuses upon heat shrink application of such film, it is to be understood that the mirror or birefringent film utilized may also be adhered to the substrate being decorated by adhesive means, or by attachment with holding devices such as staples, pins, etc. Such latter means, are of course, less desirable and aesthetically less satisfactory.

As previously indicated, the decorative film, or wrap, may be heat shrunk to a candle holder, jar, globe, votive holder, chimney, or the like, in which a candle may be placed. Alternatively, the film may be heat shrunk directly to the surface of a suitably shaped candle.

The film used in the present invention, as previously described, is a polymeric material having properties such as to appear iridescent and reflective, and possessing differing refractance of light at differing angles. For example, one such film particularly suitable for this purpose produces a color shift from blue to magenta, as the angle of viewing changes from “head-on” to “parallel”, i.e. from observation angles of 0 degrees to 90 degrees.

Such a decorative film may also be provided with a design, pattern, or other indicia imprinted thereupon, which desirably should not only improve the appearance of the candle or holder, but should cooperate with light emitted by the candle (for example, be illuminated by the light) to augment the visual effect created when the candle is lit. For example, the film applied may be colored and/or translucent, which will augment any surface features (e.g., fillets, flutes or the like) of a candle holder in a similar manner as would tinted glass. Alternatively, the film may be selectively transparent, translucent and/or opaque to provide a desired light pattern when the candle is lit. The design, if desired, can be provided by any of a number of suitable processes, such as printing (including using metallic, Day-Glo7, glow-in-the-dark, thermochromatic or other inks) or finishing, such as providing gloss, matte, or other specialty finishes to the surface of the film.

In one embodiment, in which the film is applied to a holder, the candle disposed in the holder may be formed of wax, gel or other suitable candle-forming material. Additionally, the candle could be any combustible illumination device that is wick based and burns a hydrocarbon-based fuel, which may also be a fragrance delivery system if so desired.

Due to the low shrinkage of the mirror films under consideration, there were initial concerns about whether the use of heat-shrink methods could be used to achieve the goal of the present invention. Further, there were concerns relative to the use of such films to decorate such a combustible product. However, we have found that the preferred mirror film material, in which poly(ethylene terephthalate) (PET), is utilized as the first polymer, not only may be shrink wrapped, within limits, but withstands the expected conditions (e.g., extended exposure to temperatures of up to about 125° F.) of use, but performs acceptably when exposed to such non-standard conditions as flare-ups (during which temperatures can approach about 600 to about 800° F. Although the PET based film material is preferred, the mirror film may be any of those having the birefringent optical properties described, which are capable of being shrink wrapped or otherwise applied to a substrate in accordance with the present invention, so long as the film is not adversely affected by the temperatures encountered during normal candle use. Further, if the mirror film is to be applied directly to the candle surface, we prefer that the film be heat-shrinkable at sufficiently low temperatures or brief exposure times so that the candle itself will experience little or no melting during the heat shrinking process. For the sake of convenience of discussion, the film application shall be described herein as application to a candle or to a candle holder, or simply a holder, it being understood that the terms “candle holder” and “holder” are intended to encompass all forms of globes, jars, chimneys, lamp exteriors, and enclosures suitable to surround a candle flame, through which the light of said candle flame would normally be observable.

Further, the decorating processes for the wrapped-holder and directly-wrapped-candle embodiments, respectively, each includes the step of providing a web of film appropriately sized to fit the substrate being decorated. Preferably, but not necessarily, the wrap film will be provided in individual pieces: preformed, closed loops or bands that fit over a candle or holder, or panels that are wrapped about a candle or holder. In each of these cases, the step of providing the web can include the steps of providing a continuous sleeve or sheet and severing the sleeve or sheet into the individual pieces. Alternatively, the web can be cut into pieces later in the process, such as after the web encases the candle product.

In any case, the edges of the film are overlapped and seamed in a known manner, either before (in the case of bands) or after (in the case of panels) application to the candle holder or candle. For example, the edges may be solvent sealed, heat sealed, adhesively sealed, sonically welded, or the like. In the case of bands, the edges are joined at sleeve formation, which in a preferred embodiment is done by joining opposing transverse edges of a “continuous” web of the film by tetrahydrofuran (THF) solvent applied in a known manner. Also, a further decorative design, if desired, may preferably be applied to the film before it is severed into individual pieces. In the case of bands, the design is preferably applied to the continuous web in advance of the sleeve formation.

The film or the wrap may be oriented so as to shrink predominantly in a single direction, thereby improving the predictability of the shrink-wrapping process. This can be accomplished in a known manner. For example, prior to formation of the individual pieces, while the film still comprises in a generally “continuous” web, the film can be heated and stretched in one direction. Usually this will be done in the cross-machine direction (transverse to the length of the continuous web). When the film is heated again later, in a heat-shrinking process, the film will shrink predominantly in the direction in which it has been stretched. Although not necessary to the invention, it would be preferable to orient the film so as to shrink about the candle product or holder to a much greater extent in the circumferential rather than axial direction. This facilitates orientation of the film relative to the candle or holder. The not-yet-shrunk film can be placed loosely about the candle or holder, and the top or bottom edge of the film can be aligned substantially with its intended final position. As the film shrinks (predominantly circumferentially), the film will close tightly about the candle or holder without undue axial displacement of the top and bottom edges of the film. In the case of mirror films such as may be used in the present invention, such films are not normally considered to be heat shrinkable, although we have found that they may be applied thusly if care is taken, and if the film is not substantially larger in size prior to shrinkage than after shrinkage. That is, the film must be sized so as to establish a fairly close or tight fit about the substrate to which it is to be adhered by heat shrinking. It is also to be noted that in the case of a substrate which is not cylindrical in shape, i.e. a globe, lantern, chimney, or the like which is shaped in a rounded fashion in the vertical dimension, or has a “coke bottle” or hurricane lantern shape, the heat shrinking will result in an uneven and unequal tensioning of the film upon the surface. While in some cases, this may result in poor bonding to the surface, or bubbles beneath the film, the usual effect is an interesting visual effect. That is, the uneven tensioning of the mirror film will result in areas of the film having different stretch orientation or birefringence than other areas, so that greater variation in color transmission and reflectivity will result where the film is tensioned differently.

The preferred PET based mirror film is about 25 to 59 microns thick and is oriented transversely so as to exhibit the following shrinkage characteristics when submersed in heated water for about 15 minutes:

| Water | Shrinkage (%) | |
|---|---|---|
| Temperature (° C.) | Machine direction | Cross-machine direction |
| 150 | <5% | <5% |

The individual bands or panels for application to each candle or holder can be produced by severing the continuous sleeve or sheet at a timing metered by the output of a photosensor. The photosensor can be employed to detect predetermined registration markers on the sleeve or web, in order to ensure that the sleeve or web is severed at appropriate intervals, particularly if there is a design on the film. If desired, the photosensor detection “window” can be limited to specified time periods in a known manner. If the decorative design is a repeating pattern, then the photosensor can key on a specific aspect of the pattern. If the design is not repeating or repeats less frequently than every cutting interval, then a standard registration marker can be provided. For example, a clear box with a specified border can be incorporated into each design at the same location in the individual band or panel. This permits a single web to bear more than one design, resulting in bands or panels that may differ from one another in design. This greatly increases the ease and cost-effectiveness of producing candle products decorated with varied designs.

Non-cylindrical holders or candles may also be encased by the mirror film, as indicated, using the slightly heat-shrinkable wrap as set forth above. In the preferred embodiment, this is done with a band or wrapped panel that is only slightly larger in circumference than the target candle or holder. In the case of, for example, a candle holder that is not cylindrical (i.e., it is wider in some places than others), the band or film panel should be slightly larger in circumference than the widest part of the candle or holder. This, however, is not always necessary, since the band or panel may be stretched onto a larger candle or holder if desired, particularly in the case of mirror films having a break elongation of 50 percent or higher.

The height of the film band or panel should be very close to the desired height of the finished design on the candle or holder. As noted, an oriented film can be used in known manner to provide a band that shrinks predominately in the circumferential direction, with very limited shrinkage in the axial direction.

A typical band will be described for application to a curved holder that is approximately 68.6 mm tall and has a side wall that is approximately 70.6 mm in diameter at its mouth, bulges to approximately 80.8 mm in diameter (approximately 253.8 mm in circumference) at its widest point, and tapers to approximately 40.5 mm in diameter at its base. The elongated sleeve, from which bands are formed, is approximately 260.75 mm in circumference (corresponding to approximately 83.0 mm in diameter). The sleeve is severed transversely into bands that are approximately 71.0 mm in height. Thus, each band is approximately 7.0 mm larger in circumference than the holder. Each band is also approximately 2.4 mm taller than the holder. However, due to the rounded side wall of the holder, the actual distance along the side wall from top-to-bottom actually exceeds the height of the band by a few millimeters.

The thus-formed band is then placed over the candle holder. At this stage of the process for wrapping a candle holder, it is preferred that no candle be present, although this is not necessary to the invention. This permits the holder to be oriented upside-down on a carrying surface (such as a conveyor belt or tray) for band application. This provides several advantages. In this orientation, the band can rest against the carrying surface at the outset of heat-shrinking. This prevents the wrap from overlapping the mouth of the holder. It also provides a reference surface to keep the wrap from skewing relative to the holder. A secondary advantage is that the absence of the candle at this stage avoids subjecting candle to the elevated temperatures of the heat-shrinking process, which could result in some softening or melting (although the melting can be kept to a minimum, as in the case of the application of the wrap directly to a candle).

It should be noted that the candle may be positioned in the holder earlier in the process, and may be present before the wrap is applied to the holder. For example, in the case of gel-candles or pour-in wax candles, the candle may be poured into the holder at any point in the process. In fact, it is possible that the candle may be at such a temperature when poured into the holder, that the candle itself can contribute to or achieve the heating step (as discussed below).

In the case of application of a wrap directly to a candle, it is preferred to orient the candle upright. This makes it easier to orient the film so that it does not interfere with the wick. This also minimizes the effect on the wick of whatever small degree of melting that might occur during heat-shrinking.

Once the band or panel is positioned about the candle or holder, the combination can be fed by any known mechanism (e.g., a conveyor belt) into a heating station, where the band or panel is heat shrunk onto the candle or holder. The heating station can apply hot, dry air; hot, humid air or steam; or some sequential combination of hot air and steam. The sequential combination is preferred in order to best avoid wrinkles and bubbles in the finished wrap, in a manner well known in the art, although in case of a mirror film such as used in the present invention, such wrinkles and bubbles may be desirable in that they add visual depth and effect to the finished product. For example, PET based film having the above-noted thickness and shrinkage characteristics, formed into bands having the above-noted dimensions, the bands may be subjected to four consecutive stations of hot, dry air (about one to about two seconds each at a temperature of about 100 to about 400° F., preferably about 300 to about 400° F., depending on application), and then to a station of steam (about three to about five seconds at a pressure of from about 5 to about 15 psi.)

The number, order, exposure time and intensity of the heating stations can be varied in a known manner according to the specific dimensions and characteristics of the mirror film and the candle or holder.

Once heat-shrinking or other application of the film to a substrate is complete, the wrapped candle or holder may be dried if necessary by a conventional air blow-dryer or other known mechanism, at which point the candle is ready for packaging, as is the holder once the candle is positioned therein.

Although the above-described process is preferred, alternative processes may be used. For example, alternative methods utilizing a preformed loop of heat shrink film are described in the above-noted Spiegel, et al. patent (in which the loop fits loosely over the object before heat-shrinking) or U.S. Pat. No. 4,225,049 (Inoue) (in which the loop is stretched to fit over the object). The disclosures of both of these patents are incorporated herein by reference in their entireties. An alternative method utilizing a sheet that is wrapped around the object is described in U.S. Pat. No. 5,879,496 (Bright, et al.), the disclosure of which also is incorporated herein by reference in its entirety.

We have found that the present invention provides an additional advantage in that the mirror film, when applied, protects the candle holders, which are typically glass. Specifically, the mirror film maintains the integrity of and otherwise protects the glass during production or use from, for example, abrasion or scratching. Such scratches significantly reduce the integrity of the glass. Glass, once scratched, loses compression strength and becomes more fragile. The mirror film reduces the incidents of such abrasion or scratching, and preserves the integrity of the glass.

While the present invention has been described with respect to what is at present considered to be the preferred embodiments, it should be understood that the invention is not limited to the disclosed embodiments. To the contrary, the invention is intended to cover various modifications and equivalent arrangements, some of which are discussed above, included within the spirit and scope of the appended claims. Therefore, the scope of the following claims is intended to be accorded the broadest reasonable interpretation so as to encompass all such modifications and equivalent structures and functions.

### Industrial Applicability

The inventive candle decorating method and product utilize commercially available films to provide a wrap for a candle or candle holder that cooperates with the light emitted by the candle to achieve a pleasing, altered or otherwise augmented visual effect, greatly enhancing the aesthetics of the decorative items. The method and product permit greater flexibility than known methods and products to allow a change, easily and cost-effectively, in production from among varied decorative designs, which designs incorporate variations in reflectivity and birefringence and color of luminary product.

We claim:

1. A luminary product having a decorative outer covering, said outer covering comprising a light diffractive, birefringent, and color altering plastic film.

2. A luminary product of claim 1, wherein the product comprises a candle, and said film is adhered to said candle.

3. A luminary product of claim 1, wherein the product comprises a candle and a candle holder, and said film is adhered to said candle holder.

4. A luminary product of claim 3, wherein said candle holder is selected from the group consisting of jars, votive holders, globes, and chimneys.

5. A luminary product of claim 4, wherein said candle holder comprises a glass container for said candle, and said film comprises a mirror film comprising alternating layers of at least a first polymer and a second polymer; the film appearing substantially clear at approximately a zero degree observation angle, and colored at at least one observation angle.

6. A luminary product of claim 5, wherein said film comprises a series of layer pairs having optical thicknesses of between approximately 360 nanometers and approximately 450 nanometers.

7. A luminary product of claim 4, wherein said candle holder comprises a glass container for said candle, and said film comprises a mirror film comprising alternating layers of at least a first polymer and a second polymer; said film transmitting substantially all incident visible light and reflecting light having a wavelength of from approximately 720 to 900 nanometers at approximately a zero degree observation angle, and transmitting substantially all visible light except a selected portion of red light at at least one observation angle.

8. A luminary product as set forth in claim 1, wherein said film is a multilayer film comprising alternating layers of at least a first polymer selected from the group consisting of polyethylene terephthalate and copolymers incorporating terephthalic acid and polyethylene naphthalate and copolymers incorporating naphthalene dicarboxylic acid, and a second polymer selected from the group consisting of a copolyester of cyclohexane dimethanol, polytetra-methylene ether, methacrylate, a copolymer incorporating polymethyl methacrylate, and polyethylene terephthalate glycol.

9. A luminary product comprising an illuminating device encompassed by a polymeric film comprising alternating layers of at least a first polymer and a second polymer, the film appearing substantially clear at approximately a zero degree observation angle, and colored at at least one observation angle.

10. A luminary product as set forth in claim 9, wherein said film comprises a series of layer pairs having optical thicknesses of between approximately 360 nanometers and approximately 450 nanometers.

11. A luminary product as set forth in claim 9, wherein said luminary product comprises a glass container for a candle, and said film comprises a mirror film comprising alternating layers of at least a first polymer and a second polymer; said film transmitting substantially all incident visible light and reflecting light having a wavelength of from approximately 720 to 900 nanometers at approximately a zero degree observation angle, and transmitting substantially all visible light except a selected portion of red light at at least one observation angle.

12. A luminary product as set forth in claim 11, wherein said film is a multilayer film comprising alternating layers of at least a first polymer selected from the group consisting of polyethylene terephthalate and copolymers incorporating terephthalic acid and polyethylene naphthalate and copolymers incorporating naphthalene dicarboxylic acid, and a second polymer selected from the group consisting of a copolyester of cyclohexane dimethanol, polytetra-methylene ether, methacrylate, a copolymer incorporating polymethyl methacrylate, and polyethylene terephthalate glycol.

13. A luminary product as set forth in claim 11, wherein said film comprises alternating layers of polyethylene naphthalate and polymethyl methacrylate.

14. A luminary product as set forth in claim 11, wherein said film comprises alternating layers of polyethylene naphthalate and polyethylene terephthalate glycol.

15. A luminary product comprising a decorative outer covering, said decorative outer covering comprising a light diffractive, birefringent, and color altering plastic film, said luminary further comprising an active material.

16. A luminary product as set forth in claim 15, wherein said active material is selected from the group consisting of fragrances, air fresheners, deodorizers, odor eliminators, malodor counteractants, insecticides, insect repellants, medicinal substances, disinfectants, sanitizers, mood enhancers, aroma therapy compositions, and mixtures thereof.

17. A luminary product as set forth in claim 15, wherein said active material is selected from the group consisting of fragrances, insect repellants, insecticides, and deodorizers.

18. A luminary product as set forth in claim 17, wherein said film is adhered to a candle holder, and said film comprises alternating layers of at least a first polymer and a second polymer, the film appearing substantially clear at approximately a zero degree observation angle, and colored at at least one observation angle.

19. A method for decorating a luminary product, comprising the steps of:
a) providing a web of a mirror film comprising alternating layers of at least a first polymer and a second polymer, the film appearing substantially clear at approximately a zero degree observation angle, and colored at at least one observation angle;
b) encasing with the web a substrate selected from the group consisting of candles, candle jars, candle chimneys, candle holders, lanterns, globes, and votive holders; and
c) after the encasing step, heating the web to shrink the web to conform to the shape of said substrate.

20. A method as set forth in claim 19 , wherein said substrate is a candle, and said film comprises a light diffractive, birefringent, color altering film.

21. A method as set forth in claim 20, wherein said film comprises a mirror film comprising alternating layers of at least a first polymer and a second polymer; said film transmitting substantially all incident visible light and reflecting light having a wavelength of from approximately 720 to 900 nanometers at approximately a zero degree observation angle, and transmitting substantially all visible light except a selected portion of red light at at least one observation angle.

22. A method as set forth in claim 19, wherein said substrate comprises glass enclosure surrounding a candle, and said film comprises alternating layers of at least a first polymer selected from the group consisting of polyethylene terephthalate and copolymers incorporating terephthalic acid and polyethylene naphthalate and copolymers incorporating naphthalene dicarboxylic acid, and a second polymer selected from the group consisting of a copolyester of cyclohexane dimethanol, polytetramethylene ether, methacrylate, a copolymer incorporating polymethyl methacrylate, and polyethylene terephthalate glycol.

23. A method as set forth in claim 19, wherein the encasing step comprises orienting the web so that upon completion of the heating step the film is oriented to cooperate with light emitted by the candle to augment the visual effect created when the light of the candle strikes the film

24. The method of claim 19, in which said film comprises a series of layer pairs having optical thicknesses of between approximately 360 nanometers and approximately 450 nanometers.

25. The method of claim 19, in which said film comprises a series of alternating layers of at least a first polymer and a second polymer, said film transmitting substantially all incident visible light and reflecting light having a wavelength of from approximately 720 to 900 nanometers at approximately a zero degree observation angle, and transmitting substantially all visible light except a selected portion of red light at at least one observation angle.
